(19) United States
(12) Patent Application Publication
(10) Pub. No.: US 2013/0346393 A1
(43) Pub. Date: Dec. 26, 2013

(54) RELATIONAL MODELING ENGINE

(71) Applicant: INTERNATIONAL BUSINESS MACHINES CORPORATION, Armonk, NY (US)

(72) Inventors: Georges-Henri Moll, Villeneuve-Loubet (FR); Philippe Refalo, Mouans Sartoux (FR)

(73) Assignee: INTERNATIONAL BUSINESS MACHINES CORPORATION, Armonk, NY (US)

(21) Appl. No.: 13/761,256

(22) Filed: Feb. 7, 2013

(30) Foreign Application Priority Data
Jun. 25, 2012 (GB) 1211238.9

(51) Int. Cl. G06F 17/30

(52) U.S. Cl. CPC G06F 17/30554
USPC 707/722

(57) ABSTRACT

This invention relates to a method, system and computer program product for processing instruction code to solve a problem. A method according to an embodiment includes: identifying a first relational data table operating on a second relational data table in the instruction code; selecting one or more sets of decision variables from identified tables and operation; constructing one or more equivalent sets of serialized instructions comprising the equivalent serial logical operations operating on one or more of the identified sets of decision variables; and performing the equivalent sets of serialized instructions to determine a solution to the problem.

### TECHNICAL FIELD

This invention relates to a method and apparatus for relational modeling.

### BACKGROUND

Linear programming (LP) modeling languages, mixed integer programming (MIP) modeling languages, quadratic programming (QP) modeling languages, and non-linear programming (NLP) modeling languages all include summation notation for arrays, sets, maps, and tuples. Such languages include: optimization programming language (OPL); a mathematical programming language (AMPL); and a generic algebraic modeling system (GAMS). An advantage of such languages is that they are close in form to mathematical notation used by operations research (OR) experts using those systems.

One disadvantage with present modeling languages is that users need to perform mental data structure transformations to input existing data from relational databases into those dedicated data structures, as well as to output results from internal data structures to relational databases.

Another disadvantage is that this notation introduces systematic use of index variables to express linear constraints. This can lead to very complex expressions when used together with complex/nested data structures.

A paper titled ‘Towards Relational Modeling of Combinatorial Optimization Problems’ by Pierre Flener, IJCAI 2001, addresses how to express combinatorial problems with variables that can have relations as values.

### SUMMARY

In a first aspect of the invention there is provided a method of processing instruction code to solve a problem comprising: identifying a first relational data table operating on a second relational data table in the instruction code; selecting one or more sets of decision variables from identified tables and operation; constructing one or more equivalent sets of serialized instructions comprising equivalent serial logical operations operating on one or more of the identified sets of decision variables; and performing the equivalent sets of serialized instructions to determine a solution to the problem.

An embodiment is described in terms of a machine processing an instruction code portion comprising a first table operating on a second table. Normally, such a portion is part of a whole solution wherein multiple relational operations are defined in the instruction code of the problem. An efficient embodiment is envisaged where all expressions in the instruction code are relational and there are no pure serial expressions. However, mixed relational and serial operations are a more general solution of the embodiment. Decision variables comprise regular constant value or complex expressions. By default, serialized instructions are the sum of individual products of expressions whose keys match.

Advantageously, the method further comprises identifying one or more key types associated with the relational operation for selecting decision variables based on the identified operation key types. In an embodiment, records where the key values match are used in constructing serial operations whereas records with unmatched key values are not used. In an embodiment, key types used for selecting decision variables are named as part of a relational operation identifier. For example, operation ‘x(a,b)’ includes key types ‘a’ and ‘b’ wherein variables are selected from tables with common ‘a’ and ‘b’ key values; variables without common key values are ignored. In another example, ‘x(b)’ includes key type ‘b’ only and variables are selected from the tables with common ‘b’ key values.

More advantageously the method further comprises grouping the selected decision variables into sets using one or more of the identified key types associated with the relational operation. In an embodiment, grouping key types are identified by their absence from named key types of a relational operation identifier. For example, operation ‘x(b)’ includes a key type ‘b’ but no key type ‘a’; hence the decision variables are selected from tables with common ‘b’ key values and grouped according to key type ‘a’. In other examples, if no key type is absent then there is only a single grouping. In other embodiments grouping keys might be explicitly named as part of the relational operation identifier.

Even more advantageously the method further comprises identifying key types associated with the relational tables and identifying which rows or columns of decision variables are to be used in the operation. Once the records having been identified then the decision variables in the records are identified from the keys.

In an embodiment, the method further comprises having each portion of instruction code performed in real time. In an embodiment the equivalent serial steps are performed by a real time interpreting engine. In another embodiment, an equivalent serial model is compiled and executed separately.

In an embodiment, the method further comprises repeating the identifying and constructing steps for all code portions in the instruction code. In an embodiment the identification and performance of the relational operations is performed in real time providing a just-in-time operation over the whole application. In another embodiment, each construction of equivalent serial steps is a portion of equivalent serial instruction code that is performed after compiling the whole relational instruction code.

Keys are scalar data types and can be primary, secondary and/or foreign.

Decision variables may be integer decision variables or real decision variables. Integer decision variables are abbreviated as ‘dint’. Real decision variables (a.k.a. continuous decision variables) can be abbreviated as ‘dfloat’. All variables may be scalar.

Suitably logical operations comprise summation; subtraction; and/or finding the product of two tables.

More suitably the problem is a non-linear algebra problem such as a quadratic algebra problem.

In another aspect of the invention there is provided a modeling language extension for providing the above-described method.

In another aspect of the invention there is provided an interface for providing the above-described method. The interface may be a graphical user interface in an operating system or an application. The interface may be an application programming interface.

In another aspect of the invention there is provided a computer program product.

In another aspect of the invention there is provided a computer program.

### BRIEF DESCRIPTION OF THE DRAWINGS

Embodiments of the present invention will now be described, by way of example only, with reference to the following drawings.

FIG. 1 is a deployment diagram of an embodiment.

FIG. 2 is a component diagram of an embodiment.

FIG. 3 is a flow diagram of the overall process of an embodiment.

FIG. 4 is a flow diagram of a core process of an embodiment.

FIG. 5 is example data showing two related tables before an operation by an embodiment.

FIG. 6 is example relational code as applied to the data of FIG. 5.

FIG. 7 is an example of three related tables of a problem solved by the code of FIG. 8.

FIG. 8 is example relational code handled by an embodiment for application to the data of FIG. 7.

FIG. 9 is an example transformation of relational code of FIG. 8 transformed into equivalent serial code.

FIG. 10 is another example transformation of relational code of FIG. 8 transformed into equivalent serial code.

FIG. 11 is a further example transformation of relational code of FIG. 8 transformed into equivalent serial code.

### DETAILED DESCRIPTION

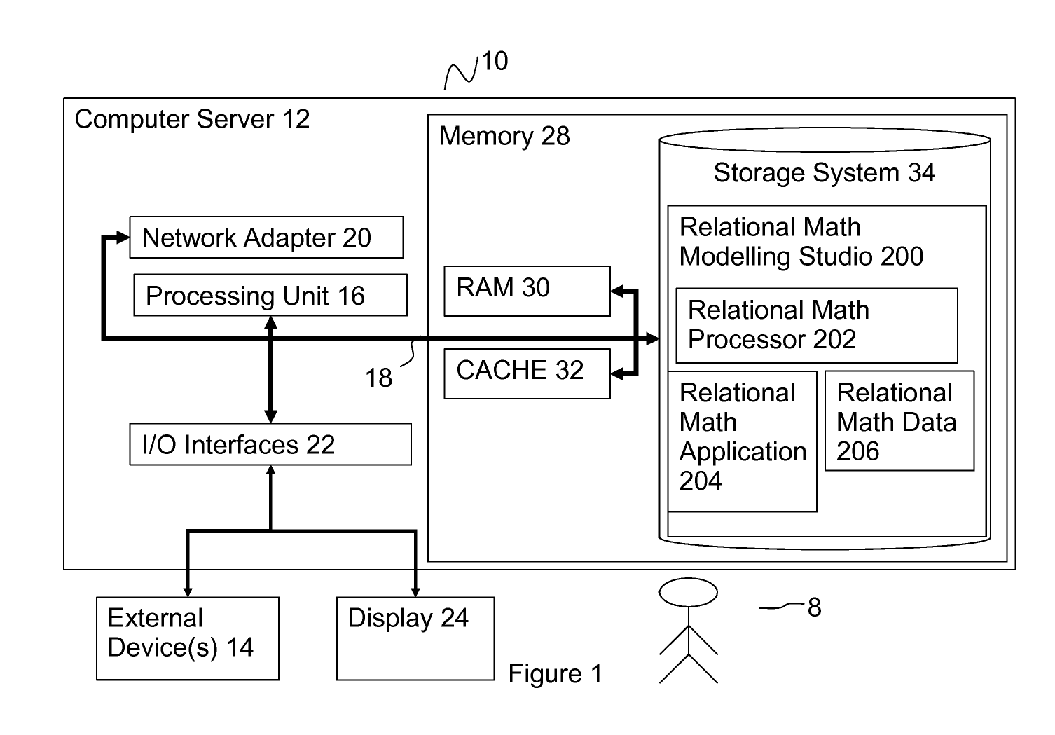

Referring to FIG. 1, there is shown a component diagram of a computer processing system 10 according to embodiments. Computer processing system 10 is operational with numerous other general purpose or special purpose computing system environments or configurations. Examples of well-known computing processing systems, environments, and/or configurations that may be suitable for use with computer processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In embodiments, a relational mathematical modeling studio 200 is described as a general computer system program module having executable instructions being executed by a computer system. Generally, program modules like relational mathematical modeling studio 200 may include routines, programs, objects, components, logic, data structures, and so on that perform particular tasks or implement particular abstract data types. Computer processing system 10 may be embodied in distributed cloud computing environments where tasks are performed by remote processing devices that are linked through a communications network. In a distributed cloud computing environment, program modules may be located in both local and remote computer system storage media including memory storage devices. As shown in FIG. 1, computer processing system 10 is shown in the form of a general-purpose computing device 12. The components of computer server 12 include, but are not limited to, one or more processors or processing units 16, a memory 28, and a bus 18 that couples various system components including memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer processing system 10 typically includes a variety of computer system readable media. Such media may be any available media that is accessible by computer processing system 10, and it includes both volatile and non-volatile media, removable and non-removable media

Memory 28 includes computer system readable media in the form of volatile memory, such as random access memory (RAM) 30 and cache memory 32, and in the form of non-volatile or persistent storage 34. Computer server 12 may further include other removable/non-removable, volatile/non-volatile computer system storage media. By way of example only, storage 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (for example, at least one) of program modules that are configured to carry out the functions of embodiments of the invention.

Other program modules may be stored in memory 28 by way of example, and not limitation, as well as an operating system, one or more application programs, and program data. Each of the operating system, one or more application programs, other program modules, and program data or some combination thereof, may include an implementation of a networking environment. Relational mathematical modelling studio 200 is provided to carry out the functions and/or methodologies of embodiments of the invention as described herein. Computer processing system 10 may also communicate with one or more external devices 14 such as a keyboard, a pointing device, a display 24, etc.; one or more devices that enable a user 8 to interact with computer system/server 12; and/or any devices (e.g., network card, modem, etc.) that enable computer processing system 10 to communicate with one or more other computing devices. Such communication can occur via I/O interfaces 22. Still yet, computer processing system 10 can communicate with one or more networks such as a local area network (LAN), a general wide area network (WAN), and/or a public network (e.g., the Internet) via network adapter 20. As depicted, network adapter 20 communicates with the other components of computer server 12 via bus 18. It should be understood that although not shown, other hardware and/or software components could be used in conjunction with computer processing system 10. Examples, include, but are not limited to: microcode, device drivers, redundant processing units, external disk drive arrays, RAID systems, tape drives, and data archival storage systems.

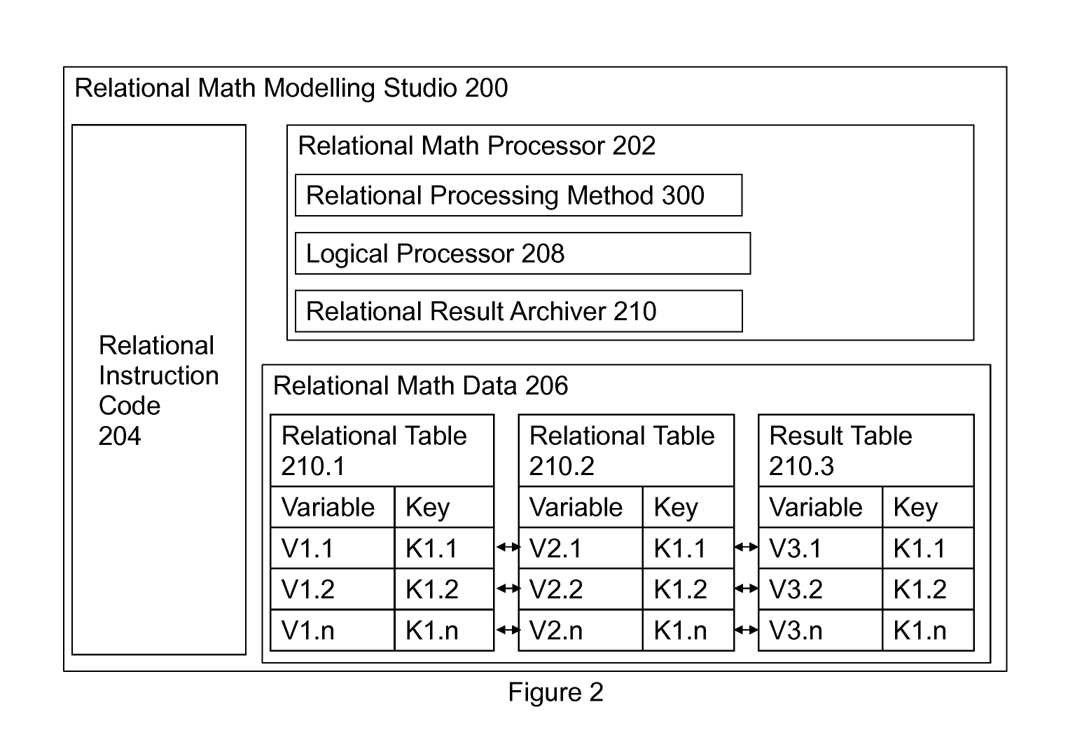

Referring to FIG. 2, relational mathematical modeling studio 200 comprises the following components: relational math processor 202; relational instruction code 204 and relational math data 206.

Relational math processor 202 is for interpreting relational problem code 204 as logical steps and having the logical steps processed. Relational math processor 202 comprises: relational processing method 300; logical processor 208; and relational result archiver 210. Logical processor 208 is a known logical processor for processing serial mathematical applications reduced from relational math application 204 to a serial form. Examples of logical process 208 would include a linear progressing engine or a quadratic processing engine using known serial instruction code. Relational result archiver 210 saves a result from logical processor 208 back into relational form.

Relational instruction code 204 is program code that represents a mathematical problem ready for solving by analysis as a mix of relational and serial instructions. In embodiments, relational instruction code 204 comprises references to relational data table structures and operations that act on those relational data table structures.

Relational math data 206 is for storing relational data structures 210.1, 210.2, 210.3, each structure is separate whereby data in one structure is related to data in another structure by virtue of shared keys. In embodiments the relational data is referred to as a table but any data structure capable of referencing another data structure could be used including tuples, arrays and registers. Relational Table 210.x (where x is 1, 2 or 3) comprises, for example: decision variables Vx.1, Vx.2, Vx.3 and respective keys K.1, K.2 and K.3 for linking the decision variables within the tables (shown by the arrows linking the cells).

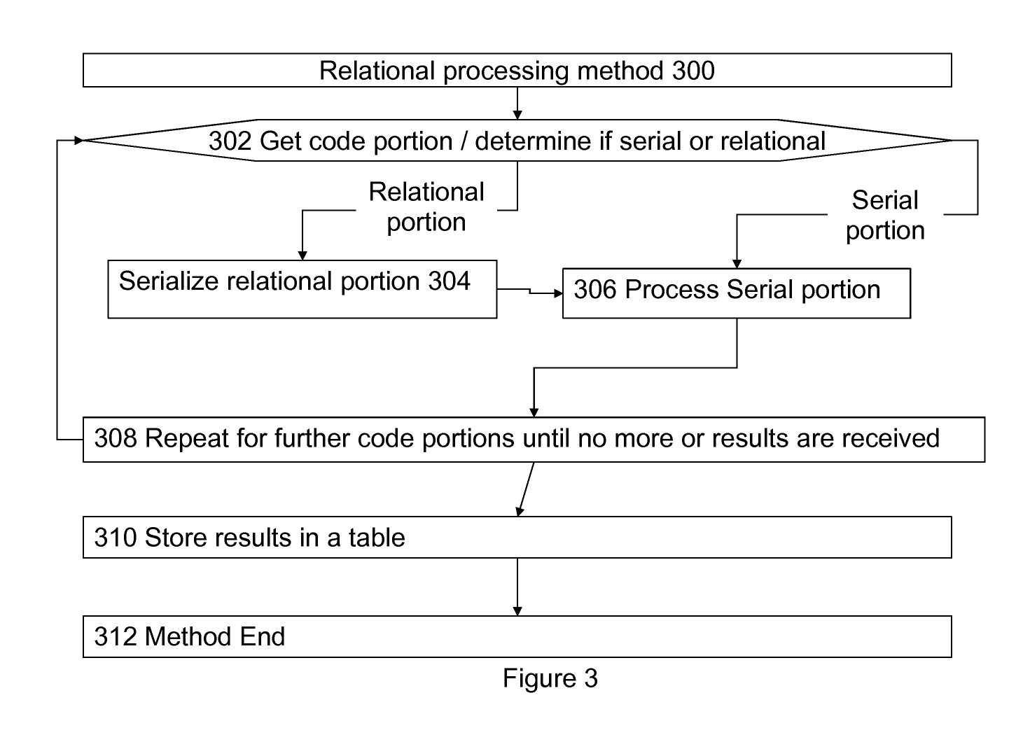

Referring to FIG. 3, relation processing method 300 comprises logical process steps 302 to 312. Relation processing method is initiated with reference to instruction code which could be relation instruction code 204 or any other relational instruction code stored by the system.

Step 302 is for getting a portion of code from relational instruction code 204 and determining if the acquired portion is serial or a relation code portion. Method 300 starts at step 302 with a first portion code and then loops back to step 302 for subsequent portions of code. If the code portion has a reference to a table structure then it is treated as a relational portion and control is passed to step 304. Else the portion is treated as a serial portion and control is passed to step 306.

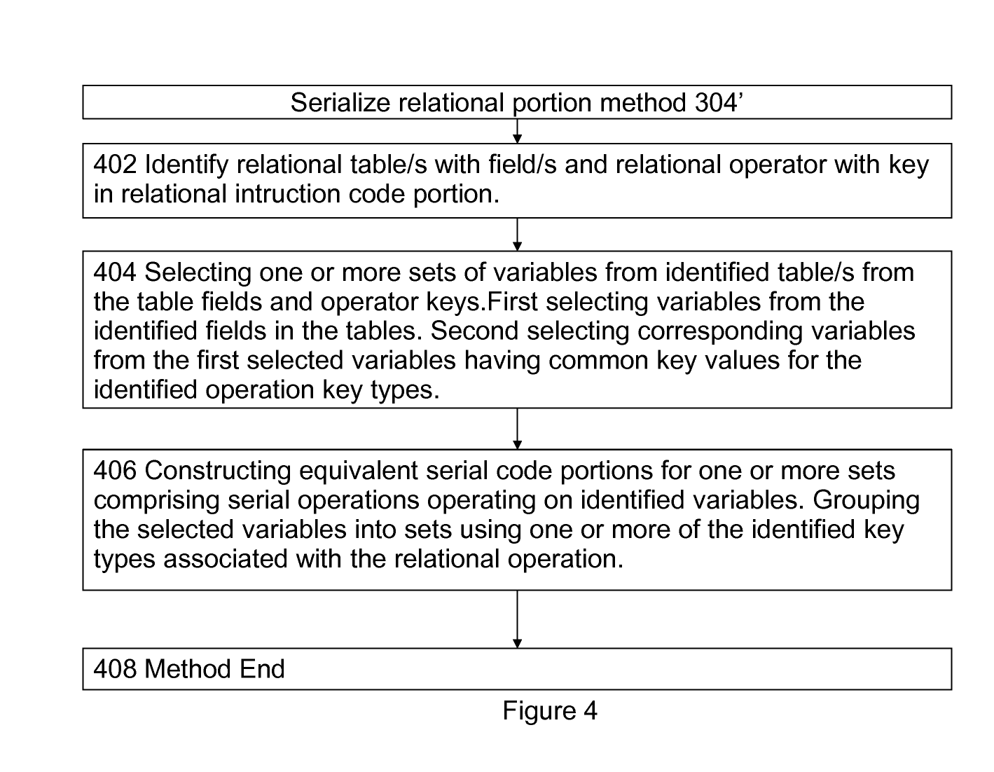

Step 304 is for converting the relational code into serial code. A embodiment of step 304 is described in more detail with reference to FIG. 4 below. After the serial code is constructed, control is passed on to step 306.

Step 306 is for processing serial portions of code in the normal manner by passing them to the logical processor 208.

Step 308 is for repeating a loop at step 302 for further portions of code until no more portions of code are located in the problem code 204. When no more problem code needs to be processed then control is passed to step 310.

Step 310 is for storing results received from logical process 208 in the relational form by having results sent to relational result archiver 210. In embodiments, serial results can be received before the problem code has been parsed through and therefore this step is preferably performed in parallel with other steps in method 300.

Step 312 is the end of the method.

Referring to FIG. 4, serialize relational portion method 304′ comprises logical process steps 402 to 408 and performs step 304 in embodiments.

Step 402 is for identifying relational table/s with key/s and relational operator/s with key/s in relational code portion. This step comprises identifying one or more key types associated with the relational operation and identifying one or more sets of variables based on the identified operation key types. In embodiments, records where the key values match are used in constructing serial operations, and records with unmatched key values are not used.

Step 404 is for selecting one or more sets of variables from identified table/s from the table keys and operator keys. This step comprises identifying key types associated with the relational tables and identifying which rows or columns of variables are to be used in the operation. Once the records having been identified then the variables in the records are identified from the table keys. First, variables are selected from the identified fields in the tables. Second, corresponding variables are selected from the first selected variables having common key values for the identified operation key types.

Step 406 is for constructing one or more equivalent serial code portions comprising serial operations operating on identified variables. In embodiments the selected variables are grouped into sets using one or more of the identified key types associated with the relational operation.

Step 408 is the end of the method and control is returned to calling method 300.

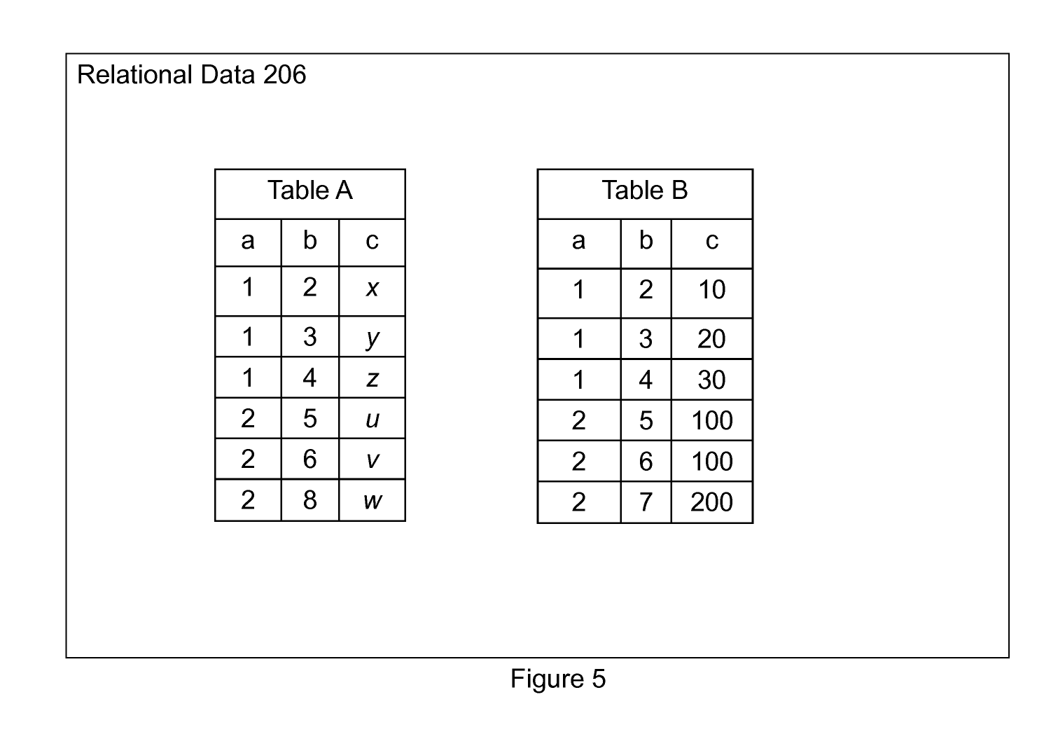

Referring to FIG. 5, example data showing two data tables before an operation is described. Table A comprises three columns a, b and c and Table B also comprises three columns a, b and c. Both tables have six rows of data. In both tables: column a and column b are key columns used to link the tables; and column c contain variables.

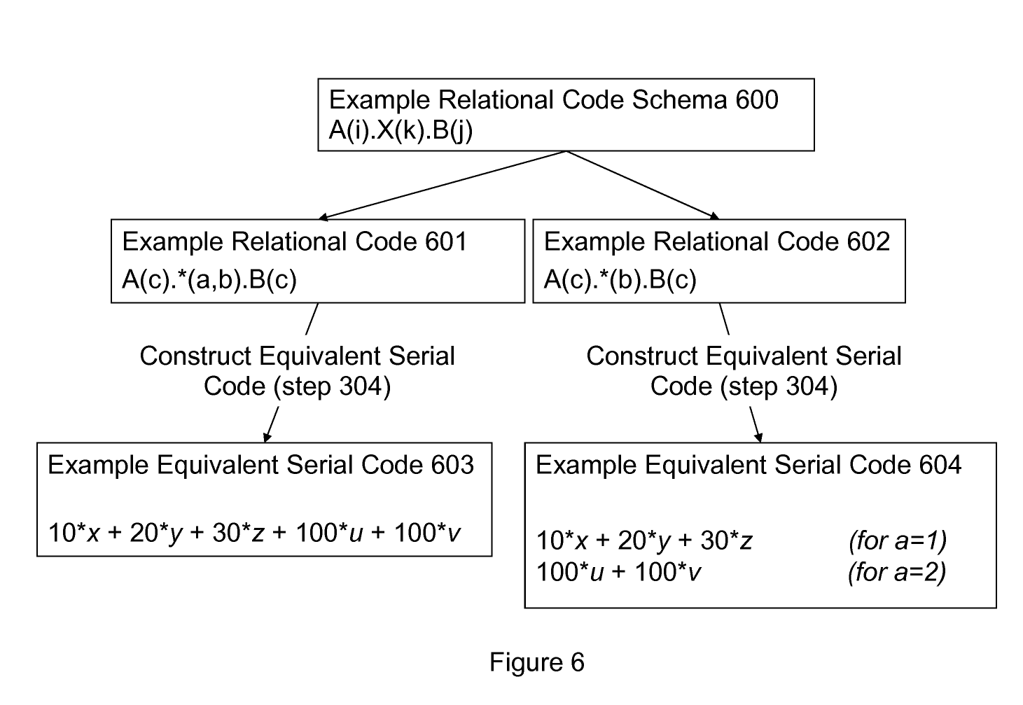

Referring to FIG. 6, example relational code comprises: example relational code schema 600=A(i).X(k).B(j); two examples 601 and 602 of relational code using this schema; and two examples 603 and 604 of equivalent serial code constructed by serialization step 304. Example relational code 601=A(c).X(a,b).B(d) and example relational code 602=A(c).X(b).B(c). A and B represent Table A and Table B respectively. X represents a logical operation or product operation such as *(multiplication) in examples 601 and 602. Parameter (i), (k) and (j) represent a key or keys. For the tables A and B, the parameters (i) and (j) define columns for operation, for example column c in example 601 and 602. For operation X, the parameter (k) defines a key type or types that are considered in determining variables with common key values. In example 601, the key types are a and b; the example equivalent serial code 603 can be seen to have only five parameters because only five variables pairs in table A and B have matching values for key types a and b. In example 602, the key type is b only and again the example equivalent serial code 604 can be seen to have five parameters in total. However, in this example, the parameters are grouped according to key ‘a’ because that key was not referenced in the relational operation. The grouping is shown as a first and second line of parameters respectively for a=1 and a=2.

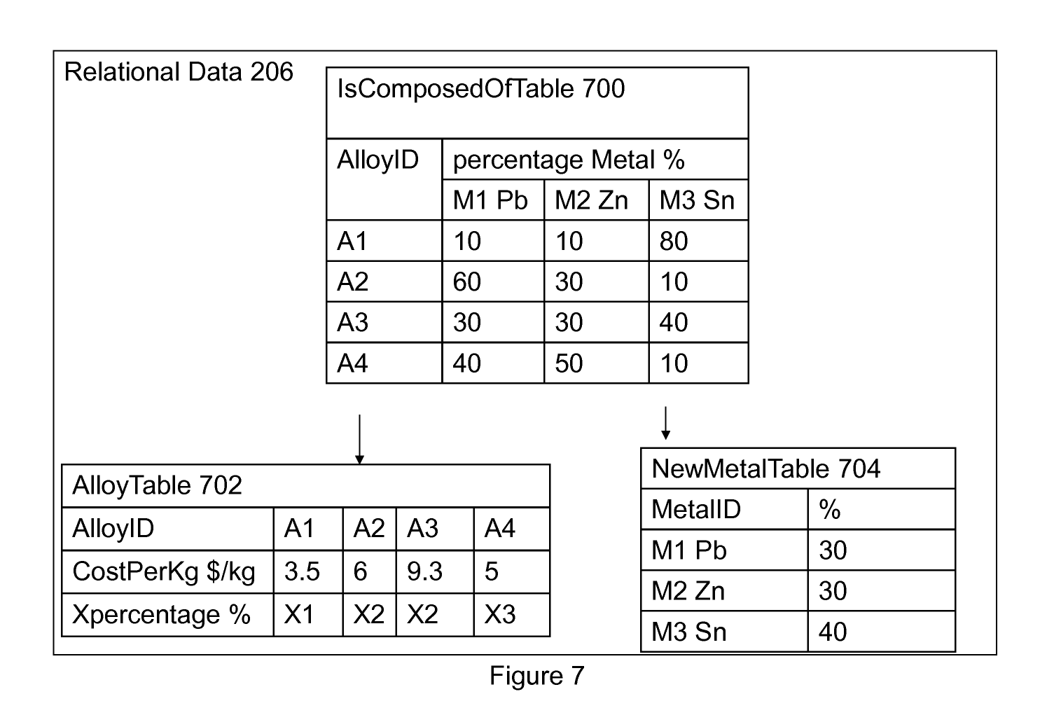

Referring to FIG. 7, another relational data example comprises: IsComposedOfTable 700; AlloyTable 702; and NewAlloyTable 704. The problem to be solved is to find the lowest cost proportion of alloys in AlloyTable 702 that form a new alloy as defined by NewAlloyTable 704 given the metal proportions as defined in IsComposedOfTable 700.

IsComposedOfTable 700 comprises records, each detailing the composition of an alloy by the percentage of metal in the alloy. Each record comprises an AlloyID field; and a percentage metal field for each of the metals (three metals in this example). In the example, the AlloyID field contains a value representing the id of one alloy from the four in the example (A1; A2; A3; or A3). In this example, the percentage metal field contains a percentage from 0 to 100%.

AlloyTable 702 comprises a record for each alloy. The record comprises: an AlloyID field; a CostPerKg field; and an Xpercentage field. AlloyID field contains a value representing the id of the alloy of A1; A2; A3; or A4. CostPerKg contains a dollar value per kg of the respective alloy. Xpercentage stores variables for the percentage of each alloy needed constructing a specific new alloy; one of the constraints of the problem is that the sum of these variables is 100%.

NewMetalTable 704 comprises a record for each metal including a MetalID field and a percentage field. The sum of the percentage field is 100%.

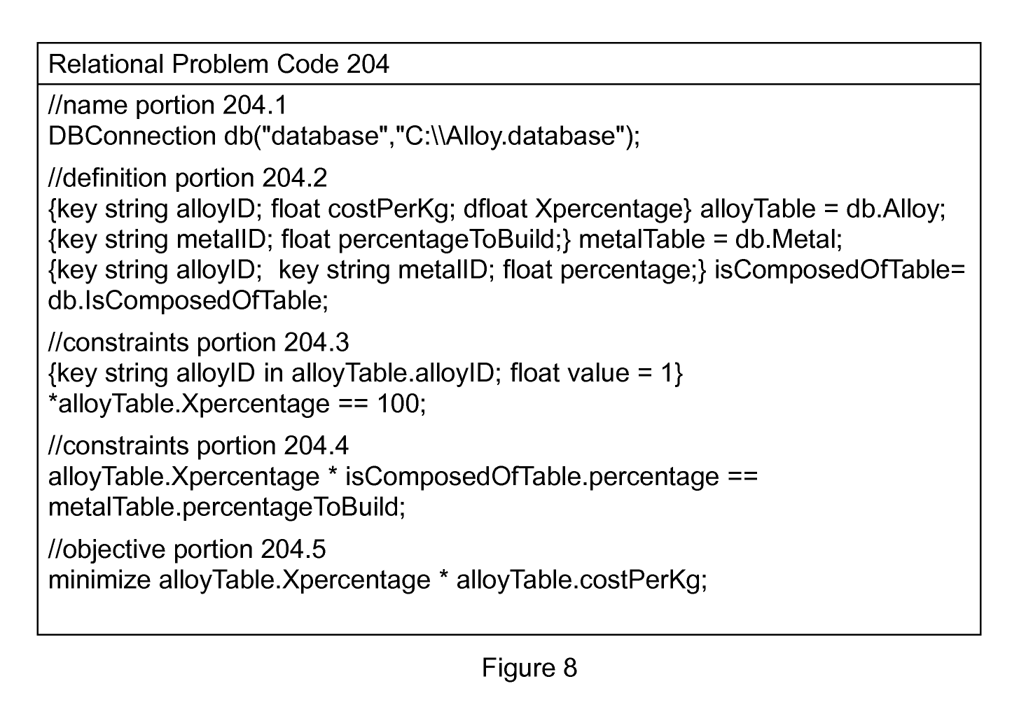

Referring to FIG. 8, relational problem code 204 comprises: name portion 204.1; definition portion 204.2; constraints portion 204.3; constraints portion 204.4 and objective portion 204.5.

Name portion 204.1 comprises the following code instructions:
DBConnection db(“database”,“C:\\Alloy.database”).

These instructions define the name and path location of the relation problem code.

Definitions portion 204.2 comprises the following code instructions:
{key string alloyID; float costPerKg; dfloat Xpercentage} alloyTable=db.Alloy;
{key string metalID; float percentageToBuild;} metalTable=db.Metal;
{key string alloyID; key string metalID; float percentage;} isComposedOfTable=db.IsComposedOfTable;

These instructions define the structure of the tables.

Constraints portion 204.3 comprises the following code instructions:
{key string alloyID in alloyTable.alloyID; float value=1}*alloyTable.Xpercentage==100.

These instructions define the constraints in terms of the relational algebra of embodiments. The constraint is that the sum of the percentages of alloys used must add up to 100%.

Constraints portion 204.4 comprises the following code instructions:
alloyTable.Xpercentage*isComposedOfTable.percentage==metalTable.percentageToBuild.

The constraint is that the sum of the metals in the alloy mix must be the same as portions of metals in the desired new alloy.

Objective portion 204.5 comprises the following code instructions minimize alloyTable.Xpercentage*alloyTable.costPerKg.

These instructions define the objective in terms of the relational algebra of embodiments. The objective is to find a solution (the alloy mix) with the lowest cost.

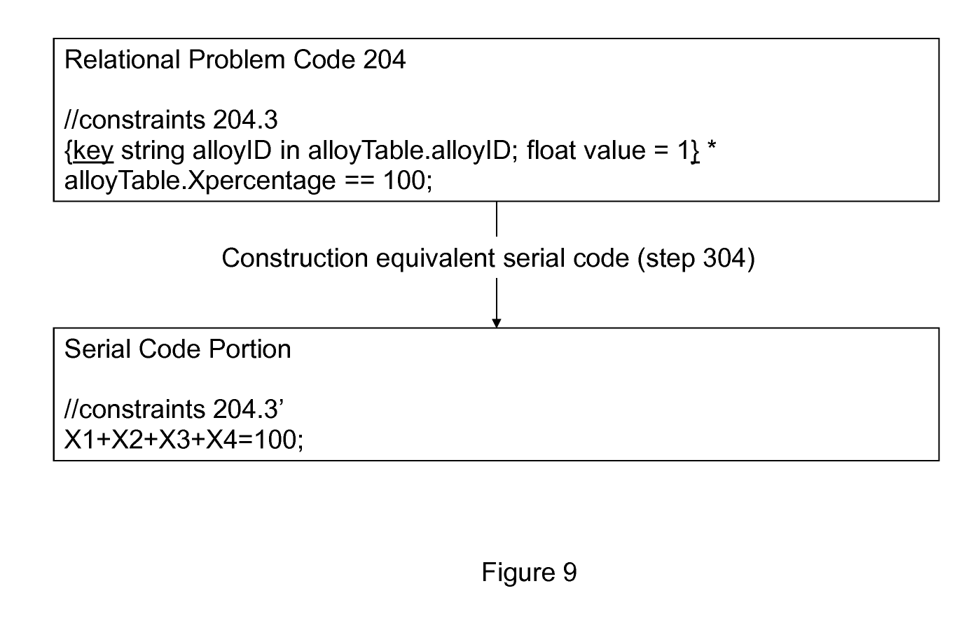

Referring to FIG. 9, constraint portion 204.3 is transformed into equivalent serial code 204.3′ by relational processing method 300 resulting in one line of serial code:
//constraints 204.3′
X1+X2+X3+X4=100

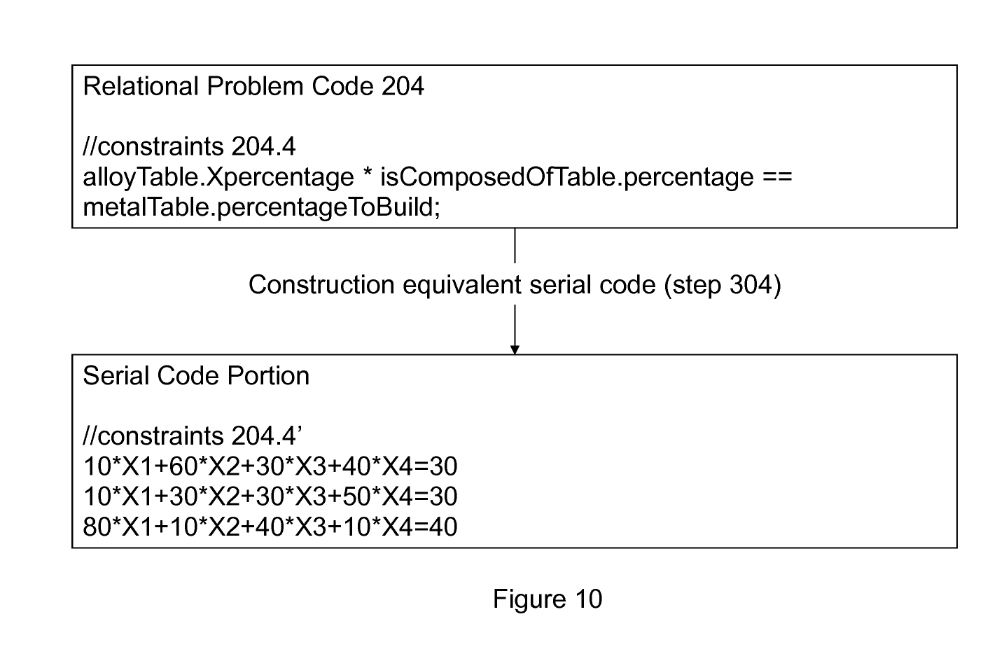

Referring to FIG. 10, constraint portion 204.4 is transformed into equivalent serial code 204.4′ by the relational processing method 300 resulting in three lines of serial code:
//constraints 204.4′
10*X1+60*X2+30*X3+40*X4=30
10*X1+30*X2+30*X3+50*X4=30
80*X1+10*X2+40*X3+10*X4=40

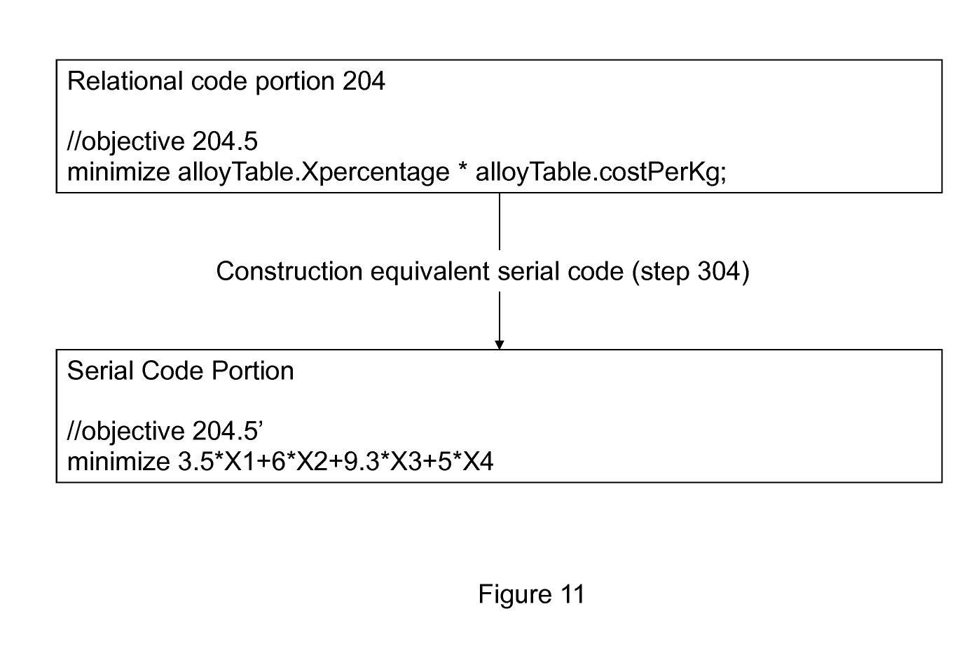

Referring to FIG. 11, objective portion 204.5 is transformed into equivalent serial code 204.5′ by relational processing method step 406 resulting in one line of serial code:
//objectives 204.5′
minimize 3.5*X1+6*X2+9.3*X3+5*X4

Once the serial code portion has been processed by logical processor 208 then the solution is saved in AlloyTable 702.

Further embodiments of the invention are now described.

It will be clear to one of ordinary skill in the art that all or part of the method of the embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to embodiments of the present invention may suitably be embodied in logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, embodiments of the present invention may be realized in the form of a computer implemented method of deploying a service comprising steps of deploying computer program code operable to, when deployed into a computer infrastructure and executed thereon, cause the computer system to perform all the steps of the method.

In a further alternative, embodiments of the present invention may be realized in the form of a data carrier having functional data thereon, the functional data comprising functional computer data structures to, when loaded into a computer system and operated upon thereby, enable the computer system to perform all the steps of the method.

It will be clear to one skilled in the art that many improvements and modifications can be made to the foregoing exemplary embodiment without departing from the scope of the present invention.

1. A method of processing instruction code to solve a problem, comprising:
identifying a first relational data table operating on a second relational data table in the instruction code;
selecting one or more sets of decision variables from identified tables and operation;
constructing one or more equivalent sets of serialized instructions comprising equivalent serial logical operations operating on one or more of the identified sets of decision variables; and
performing the equivalent sets of serialized instructions to determine a solution to the problem.

2. The method according to claim 1, further comprising:
identifying one or more key types associated with a relational operation for selecting decision variables based on the identified operation key types.

3. The method according to claim 2, further comprising:
grouping the selected decision variables into sets using one or more of the identified key types associated with the relational operation.

4. The method according to claim 2, further comprising:
identifying key types associated with the relational tables and identifying which rows or columns of decision variables are to be used in the operation.

5. The method according to claim 1, further comprising:
performing each portion of instruction code in real time.

6. The method according to claim 1, further comprising:
repeating the identifying and the constructing for all code portions in the instruction code.

7. The method according to claim 1, wherein the decision variables are integer decision variables or real decision variables.

8. The method according to claim 1, wherein the logical operations comprise at least one of summation, subtraction, or finding a product of two tables.

9. The method according to claim 1, wherein the problem is a linear algebra problem.

10. The method according to claim 1, wherein the problem is a quadratic algebra problem.

11. A system for processing instruction code to solve a problem, the system performing a method comprising:
identifying a first relational data table operating on a second relational data table in the instruction code;
selecting one or more sets of decision variables from identified tables and operation;
constructing one or more equivalent sets of serialized instructions comprising equivalent serial logical operations operating on one or more of the identified sets of variables; and
performing the equivalent sets of serialized instructions to determine a solution to the problem.

12. The system according to claim 11, the method further comprising:
identifying one or more key types associated with a relational operation for selecting decision variables based on the identified operation key types.

13. The system according to claim 12, the method further comprising:
grouping the selected decision variables into sets using one or more of the identified key types associated with the relational operation.

14. The system according to claim 12, the method further comprising:
identifying key types associated with the relational tables and identifying which rows or columns of decision variables are to be used in the operation.

15. The system according to claim 11, the method further comprising:
performing each portion of instruction code in real time.

16. The system according to claim 11, the method further comprising:
repeating the identifying and the constructing for all code portions in the instruction code.

17. The system according to claim 11, wherein the decision variables are integer decision variables or real decision variables.

18. The system according to claim 11, wherein the logical operations comprise at least one of summation, subtraction, or finding a product of two tables.

19. A computer program stored on a computer readable storage medium and loadable into the internal memory of a digital computer, comprising software code portions, when the program is run on a computer, for performing the method claim 1.
